(19) United States
(12) Patent Application Publication
(10) Pub. No.: US 2010/0175084 A1
(43) Pub. Date: Jul. 8, 2010

(54) INTERACTIVE TELEVISION SYSTEM WITH MESSAGING AND RELATED PROMOTIONS

(76) Inventors: Michael D. Ellis, Boulder, CO (US); Joseph M. Guiliano, Manalapan, NJ (US)

Correspondence Address: ROPES & GRAY LLP, PATENT DOCKETING 39/361, 1211 AVENUE OF THE AMERICAS, NEW YORK, NY, 10036-8704, US

(21) Appl. No.: 12/724,360

(22) Filed: Mar. 15, 2010

Related U.S. Application Data
(63) Continuation of application No. 10/195,228, filed on Jul. 11, 2002, now abandoned.
(60) Provisional application No. 60/305,084, filed on Jul. 12, 2001.

(51) Int. Cl. H04N 7/025

(52) U.S. Cl. 725/32; 725/42; 725/51

(57) ABSTRACT

A system is provided in which messages and promotions are linked together in an interactive television system. The messages may be electronic mail messages. When the system displays a message, it displays the associated promotion on the same screen. The television viewer may select the promotion to see more details and to order the product or program advertised or to perform other actions related to the product or program. The system may also include a program guide and allow promotions to be linked to program guide data, in which case the system may allow the television viewer to access program guide features by selecting the promotion.

This application claims the benefit of U.S. provisional application No. 60/305,084, filed Jul. 12, 2001.

### BACKGROUND OF THE INVENTION

This invention relates to interactive television program guide, systems (“IPGs”), and more particularly, interactive television program guide systems which provide access to and use of messaging, promotional ordering (e.g., promotions may contain an option to order the product or service featured) and other systems.

Interactive television program guides are well known. Such guides allow users to display television program schedule information. Typical program guides allow users to view information for television programs and channels and audio programs and channels. For example, a program guide may provide information on regular television channels, premium television channels, pay-per-view (“PPV”) television channels, and music channels. A variety of display formats are typically supported. For example, program listings may be organized by time, by channel, and by category (sports, children, comedy, movies, etc.).

Set-top box systems may also provide access to advanced services and features, such as video-on-demand, near video-on-demand, time shifting TV, home shopping, Internet browsing, electronic mail, banking, enhanced television (interactive programs), data services, and wagering services.

Some IPGs include a messaging feature. This feature allows text messages to be sent to one or more receiver stations. One use of text messaging systems is to send promotions to the viewer. For example, a text message may be sent to cable or satellite television system subscribers informing them that a boxing match will be shown on pay-per-view or that a cable modem is available for purchase. The text promotion, however, does not contain any graphics to entice the viewer to buy the item. Also, the ordering process is complicated. If the viewer wants to watch the boxing match, the user must leave the message screen, call up the program listings, search for the boxing match, and then purchase it. To buy the cable modem, the viewer might have to leave the messaging feature, go to a shopping feature, pick the appropriate on-line catalog, find the desired product, and then purchase it.

Some program guides are deployed on devices which also support bidirectional electronic mail (“e-mail”) messaging. E-mail messages can be sent and received. Both the system operator and individual subscribers can receive and send e-mail messages to each other. An e-mail message sent to the viewer may include a promotion or advertisement for an item, program, or service. However, to buy that item, the viewer has to leave the e-mail feature, go to the program guide or shopping feature, find the advertised item, and then purchase it.

It is envisioned that, in interactive television systems, one of the most important features will be the ability of the television viewer to purchase products and services. These items may include, but are not limited to, those available via on-line shopping catalogs. The items may also be television and music programming, such as pay-per-view movies or events, video-on-demand programs, near video-on-demand programs, premium channels, or packages of such programming. They will also include group purchasing options as well as the ability to purchase products and services for third persons.

Therefore, it would be desirable to provide interactive program guides and other systems in which the content of promotions included in messages and electronic mail is enhanced with graphics, interactivity and other features. For the foregoing reasons, there is a need for an interactive television program guide system that displays graphic promotions that are related to messages.

There is also a need for an interactive television program guide system that allows the viewer to purchase programs and other items from an interactive promotion shown in conjunction with a message.

There is a further need for an interactive television system that displays related promotions along with e-mail messages, and allows the viewer to purchase the advertised items from that promotion.

Because the television viewer may not have a reason to use the interactive television feature related to purchasing of a specific item, it is advantageous to allow the viewer to purchase the item at the time it is promoted, rather than having to go to a separate application or sub-system. Interactive promotions and advertisements in a program guide may, also allow the viewer to obtain additional information about an item available for purchase.

### SUMMARY OF THE INVENTION

These and other objects of the invention may be accomplished in accordance with the principles of the present invention by providing enhanced messaging, electronic mail, video on demand, graphic advertisements and additional notification systems. The interactive television program guide application and other applications may be implemented on any suitable platform. One suitable platform may be user television equipment that is based on a set-top box or that is based on a device that incorporates set-top box functions such as an advanced digital television receiver.

Another suitable platform may involve a client-server architecture based on a server and user television equipment. The server, which may be located at a cable system headend or other suitable remote location, may operate in cooperation with the user television equipment. With client-server arrangements, interactive program guides and other applications that are implemented on the platform may be partially implemented on the user television equipment and partially on the server, rather than being implemented entirely on the set-top box. For example, program guide functions related to displaying menu screens may be implemented at the user television equipment, whereas functions related to maintaining the program guide database or related to video-on-demand features may be implemented on the server.

Messaging and e-mail systems may be integrated within the program guide or can be separate applications which may be accessible from the program guide. For example, the program guide may provide an on-screen option to invoke an e-mail program or another non-program-guide application. The program guide and other applications may also be activated via dedicated button(s) such as a “Guide” remote control button. The specification and drawings of U.S. patent application Ser. No. 09/346,134, entitled “Interactive Television Program Guide System That Serves As A Portal,” is incorporated herein by reference for all purposes and, in particular, for how a program guide and other interactive content applications may be implemented and integrated on any suitable platform.

In one possible embodiment, interactive, graphical, and non-graphical promotions may be linked to messages in an interactive television system.

Some features may allow multiple viewers to read, and optionally respond to, messages, such as e-mail messages. Other features may allow an advertiser to create promotions and advertisements and to link some of the promotions and advertisements to some of the messages. When the TV viewer reads the message, a linked promotion or advertisement may be displayed at the same time, on the same screen. For example, if the advertisement contains or consists of a graphic, this may be displayed alongside the description of the message in a listing of messages and can be displayed alongside or within the message.

The promotions and advertisements may be preferably interactive. When a viewer is reading the promotional message and a related advertisement is displayed, the viewer may be able to select the advertisement (e.g., by moving a cursor to it and “clicking” on it). Thereafter, the system may respond by performing the operations programmed for the interactive element(s). For example, a viewer may be able to buy the product or service being promoted by clicking on the advertisement.

In some embodiments, a cable operator may be able to promote a pay-per-view event by sending an e-mail message to some or all of the customers able to watch that event. A graphic advertisement for a boxing match may also be created and linked to the e-mail message. The system may deliver the e-mail message to the desired set of customers, and notify each of them that they have mail. The specification and drawings of WO 00/11,585, entitled “Electronic Mail Notification System,” is incorporated herein by reference for all purposes and, in particular, for how an electronic mail notification system can operate in conjunction with a program guide.

When a viewer or the system activates the e-mail system, display equipment may display the message and the linked advertisement on the same screen. The viewer may be able to read the message and click on the advertisement to buy, for example, a PPV event without having to go to the program listings in the interactive program guide.

In some embodiments, the message and the advertisement may be related to a product that the viewer can order interactively over the television. The viewer may be able to read the message and select the advertisement. When the viewer selects the advertisement, the system may display more information about the product, may allow the viewer to buy the product, or may go to an Internet site related to the product.

A program guide may be linked with the messaging and promotion features described above. For example, when a promotion is related to a TV program, this information may be used in a query to the program guide database and may allow the viewer to use functions from the program guide related to the viewer's selection. For example, when the viewer clicks on a linked advertisement for a program, the system may enable the viewer to see the description of the program from the guide database. The viewer may also be enabled to tune to the program (e.g., when it is currently being broadcast or when it is available via video-on-demand), set a reminder for it, schedule it for recording, see on what other times and channels it might be shown, and do anything else the program guide supports related to the program.

In some embodiments, graphical advertisements may be targeted to groups of users. For example, viewers who previously purchased boxing, wrestling or concert PPV events may be targeted with messages advertising similar programming in the future. Likewise, users who ordered memorabilia connected with an event, team and/or organization may be sent e-mail messages advertising similar items in the future. Targeting of advertisements may be performed by any criteria capable of being classified and/or tracked by the system operator concerning its viewers and/or obtained from a third party vendor (e.g., demographic data, affiliation information, information on past purchases and/or internet preferences).

In some embodiments, users may be enabled to forward messages to purchase products and services to third parties. For example, a message promoting a PPV event may be received by a viewer who wishes to pass on the information or purchase the event for a friend. The system may be programmed with an interactive graphic to enable the user to forward the message or make the purchase for other users in an e-mail distribution list (e.g., a special interest film group). In forwarding the message, the user may, be given the option to purchase the event for the third party. In the case of a video-on-demand programming, the third party may receive the forwarded message along with notification that the program is available for no charge viewing. Alternatively, the message may have a graphic element signifying the availability of an electronic gift certificate which can be sent to a third party to enable the party to watch a program of his or her choosing that meets the criteria the sender sets for the gift certificate (e.g., a specific program or any program matching a specified criteria, e.g., price and/or movie rating). U.S. patent application Ser. No. 09/356,245, entitled “Television Message System,” is incorporated herein by reference for all purposes and, in particular, for how pay-per-view program viewing coupons and gift certificates may be used in conjunction with a program guide.

The system may support the capability of adding additional promotional graphical content to messages in the process of forwarding them to the third party. For example, a message may include a display of discount information for a PPV fight where the discount to the person who forwarded the message is determined by the number of recipients who purchase the event. Each recipient may be informed of the discount and provided with information on additional discounts available should the recipient refer the message to additional third parties who elect to purchase the event.

The system may support the capability of linking a promotion to a message sent by a subscriber of the television system. One subscriber may send a message, and a second subscriber may receive the message with a promotion automatically linked to the message based on the content of the message. For instance, a subscriber may send electronic messages based on a program the subscriber is currently watching as described in U.S. patent application Ser. No. 09/356,245, filed Jul. 16, 1999, which is hereby incorporated by reference herein in its entirety. Additionally, subscribers may electronically chat about programs they are currently watching as described in U.S. patent application Ser. No. 09/356,270, filed Jul. 16, 1999, which is hereby incorporated by reference herein in its entirety. In systems enabling a user to e-mail or chat about programs being watched, the e-mails or chat messages may be inherently linked to the programs. Therefore, advertisements for future broadcasts of episodes of the subject-matter program, broadcasts of programs of a similar genre as the subject-matter program, or merchandise related to the subject-matter program may be linked to the e-mail messages and/or chat messages.

In some embodiments, it may be desirable to generate targeted messages to users to purchase video-on-demand and near video-on-demand programming. Based on past viewing habits or purchases, users may be sent information on related programming. For example, if a viewer were to watch a single episode of the Honeymooners on regular television or via video-on-demand, the system may take note of this fact and generate a message to the viewer that a package of episodes (including rarely broadcast “lost” episodes) is available for viewing at a discounted price. Once a viewer purchases a package, the system may periodically send messages to the viewer informing him or her as to the number of programs left in the package. An interactive messaging system may also interact with a program guide to automatically set the programs in the package for recording and/or reminding.

The content of messages may be scanned to determine which graphical advertisements are to be displayed alongside or within the message. For example, a message which includes the character string “Star Trek” may be accompanied with an advertisement for Star Trek related television shows, movies and/or video-on-demand programming. Similarly, a message including the character string “Star Trek” may be accompanied with an advertisement for Star Trek related products (e.g., toys, books, etc.). In some embodiments, the automatic scanning of message content may be limited to those messages that originate from the system operator. However, the automatic scanning may also not be so limited (e.g., when association is performed locally at a receiver system).

Furthermore, in television program guides that allow users to send electronic mail messages based on the program(s) being watched (see, e.g., U.S. patent application Ser. No. 09/356,245, filed Jul. 16, 1999, which is hereby incorporated by reference herein in its entirety), targeted messages and promotions may be sent to users based on the programs during which the users generate the electronic mail messages. Additionally, user generated electronic messages may be accompanied by advertisements (e.g., interactive graphical advertisements) for related programming and products. The advertised programming and products may relate to the program being watched during which the electronic message was generated. The program being watched may be automatically determined, and related graphical advertisements may be automatically displayed alongside or within the user messages.

Purchasing circles may be supported in some embodiments. One such circle may be viewers interested in the book club selections of a talk show. Approximately once a month, the host of a television show discussing books will announce the next month's selection(s) which immediately leads to heightened demand for the new selection(s). In systems capable of detecting which customers watched the television show, interactive messages may be sent to those viewers enabling them to order the next month's selection or a prior month's selection(s) by clicking on, for example, graphical depictions of the book covers. An interactive application may also be overlaid on the television show with an interactive message to enable viewers watching the show to order a book. The ordering process may be a one-step/one-click process or a multi-step process where the ordering screen(s) are overlaid over a portion or all of the television program video signal. The overlays may be variably transparent (allowing the viewers to continue watching the underlying program) or opaque.

Access to purchasing circles may also be through a program guide. The program guide may support interactive ordering for items in conjunction with program listings (e.g., a graphic might be displayed with program listings to indicate that there are items available for purchasing or to give the user the option to receive messages with accompanying advertisements related to a show).

When a user selects a graphical advertisement, the option for the user to be added to a distribution list for similar messages in the future may be provided. For example, a viewer may opt to receive messages concerning new book club selections. Messages thereafter may be sent announcing new selections and, where the messages have an interactive component, the user may be able to order the product(s) associated with the messages.

Some embodiments may also provide the operator with the flexibility to target groups of viewers to receive messages for selected purchasing circles. Similar in nature to how advertisements may be targeted, the inclusion/exclusion criteria for sending messages may be set by a variety of criteria. For example, a purchasing group may be established that is targeted to the members of a local civics groups. A mechanism may also be provided which enables a viewer that is targeted with a message to opt not to receive future messages directed to one or more groups.

The operator or users may be allowed to include or append additional audio-visual content to a message. For example, a system message promoting a PPV program may include a promotional video clip that may be automatically displayed when the message is displayed or be otherwise selectable by the user. Alternatively, the message itself may be an interactive video clip promoting a video-on-demand program which could optionally be purchased by the user entering a command to purchase the program.

Some embodiments may enable users to forward messages to other viewers in which the system may embed interactive content enabling the recipient to view the program. For example, while viewing a sports program, a facility may allow a user to compose a message (which may be selected from a list of preset message types) recommending the program to a third person. In forwarding the message, the system may add a graphical interactive icon or advertisement that would allow the third person to view the program at a later time (e.g., time shifting TV).

Further features of the invention, its nature and various advantages will be more apparent from the accompanying drawings and the following detailed description of the preferred embodiments.

### BRIEF DESCRIPTION OF THE DRAWINGS

FIG. 1 is a schematic block diagram of an illustrative interactive system in accordance with certain embodiments of the present invention.

FIG. 2 is a schematic block diagram of illustrative local distribution equipment and user television equipment in accordance with certain embodiments of the present invention.

FIG. 3 is a schematic block diagram of illustrative local distribution equipment and user television equipment in accordance with certain embodiments of the present invention.

FIG. 4 is a schematic block diagram of illustrative user television equipment shown in FIGS. 2 and 3 in accordance with certain embodiments of the present invention.

FIG. 5 is a diagram of an illustrative message entry screen that may be used by an operator to enter targeted and untargeted messages in accordance with certain embodiments of the present invention.

FIG. 6 is a diagram of an illustrative advertisement entry screen that may be used by an operator to enter promotions in accordance with certain embodiments of the present invention.

FIG. 7 is a diagram of an illustrative screen that may be used to link advertisements with messages in accordance with certain embodiments of the present invention.

FIG. 8 is a diagram of an illustrative advertisement entry screen that may be used to enter graphical promotions and link them to other content in accordance with certain embodiments of the present invention.

FIG. 9 is a diagram of an illustrative interactive program guide menu screen in accordance with certain embodiments of the present invention.

FIG. 10 is a diagram of an illustrative interactive program guide listing screen in accordance with certain embodiments of the present invention.

FIG. 11 is a diagram of an illustrative screen containing a list of messages in accordance with certain embodiments of the present invention.

FIG. 12 is a diagram of an illustrative interactive message screen in accordance with certain embodiments of the present invention.

FIG. 13 is a diagram of an illustrative interactive message screen in accordance with certain embodiments of the present invention.

FIG. 14 is a diagram of an illustrative advertisement information screen that may be accessed from the message screen of FIG. 12 in accordance with certain embodiments of the present invention.

FIG. 15 is a diagram of an illustrative advertisement information screen that may be accessed from the message screen of FIG. 13 in accordance with certain embodiments of the present invention.

FIG. 16 is a flow chart of illustrative steps involved in operating the system of the present invention in accordance with certain embodiments of the present invention.

FIG. 17 is a diagram of an illustrative interactive television system in accordance with certain embodiments of the present invention.

### DETAILED DESCRIPTION OF THE PREFERRED EMBODIMENTS

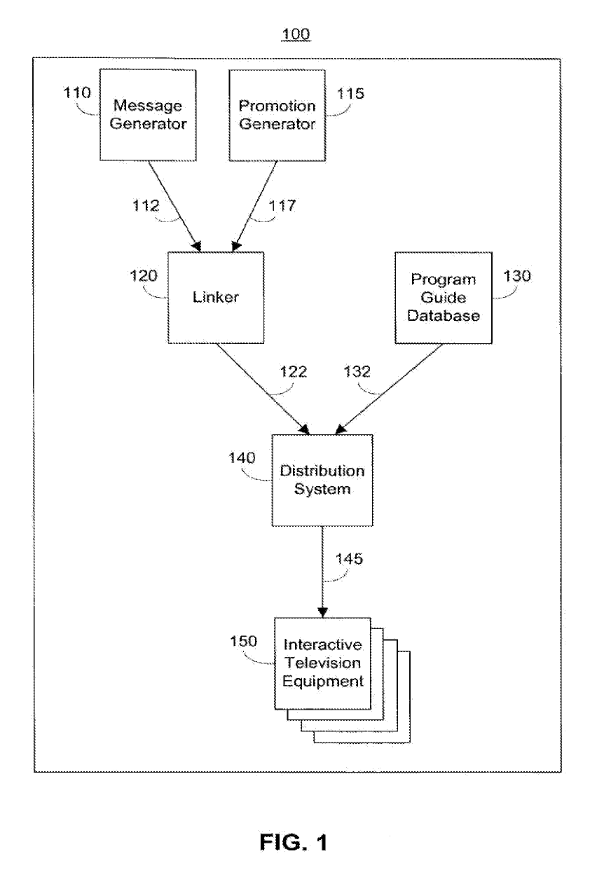

An illustrative messaging system 100 in accordance with the present invention is shown in FIG. 1. Message generator 110 is a system for generating messages for television viewers. There may be multiple message generators but only one has been shown to avoid over-complicating the drawing. It may be implemented using any suitable e-mail or other message generating hardware and software. It may alternatively be a custom system or set of systems for generating messages. The message generator includes the ability to enter text, and possibly other media types, into the messages. It also preferably includes the ability to address the messages to a subset of television viewers. For example, messages may be sent to all viewers in the interactive television system, viewers with access to a channel or group of channels, viewers in a particular geographical area, viewers who have watched a particular program or programs previously, viewers who previously purchased certain types of items previously, viewers served by a particular distribution network (such as a cable system), or an individual household or viewer. Messages may be delivered to viewers using equipment and techniques like those shown in PCT publication WO 00/11,585 and U.S. patent application Ser. No. 09/717,729, filed Nov. 21, 2000, both of which are hereby incorporated by reference herein in their entireties.

Promotion generator 115 is a system for creating or importing promotions or other content for use within an interactive television system. It, likewise, may be multiple promotion generators but only one has been shown to avoid over-complicating the drawing. Promotions may be graphical, text, video, audio, animations, or any suitable combination of media. The promotion generator 115 provides the ability to enter or link to the desired media content. It may also include the ability to enter other information related to the promotion, such as targeting information, information on when the promotion is to be shown, or other such information. Promotions may be delivered to viewers using equipment and techniques like those shown in U.S. patent application Ser. No. 09/034,939, filed Mar. 4, 1998 and U.S. patent application Ser. No. 09/070,604, filed Apr. 30, 1998, both of which are hereby incorporated by reference herein in their entireties.

Linker 120 provides the ability to associate output from the promotion generator to one or more messages from the message generator. It is anticipated that certain messages and promotions may be easily linked automatically (e.g., both the message and promotion are indexed with the same program title) or manually. The linker provides the ability to identify promotions and messages to be linked. The linker creates an association between a message and one or more promotions. The association may be added to the message or the promotion, or it may be a separate data object.

Message generator 110 may send messages to linker 120 via data path 112. Alternatively, linker 120 may be part of message generator 110. In another alternative, messages may not be sent to linker 120, and may instead be referred to using a unique identifier provided by message generator 110.

Promotion generator 115 may send promotions to linker 120 via data path 117. Alternatively, linker 120 may be part of promotion generator 115. In another alternative, promotions may not be sent to linker 120, and may instead be referred to using a unique identifier provided by the promotion generator 115.

Optionally, system 100 may include a program guide. If a program guide is supported, program guide database 130 may provide the ability to collect and enter information relating to television programs, such as program titles and descriptions, channels, scheduled start times and run times, ratings, pay-per-view pricing, etc.

If system 100 includes a program guide database 130, promotion generator 115 may include the ability to link a promotion to a program, a group of programs, a television channel, a television network, or the like. The program guide 130 may be stored on a remote server or may be located locally at the user television equipment.

Messages and promotions may be provided to distribution system 140 either directly, or via linker 120 on data path 122. Program guide data may be provided to distribution system 140 via data path 132. Distribution system 140 may be any appropriate system for distributing promotions, messages, and program guide data to multiple interactive television equipment 150 over data path 145. This may include cable distribution, satellite distribution, telephone distribution, broadcast distribution, or any other suitable distribution method or combination of methods. Different parts of the data may be sent via separate facilities. It is preferred that the primary distribution system have a high bandwidth and support bidirectional communications.

Message generator 110, promotion generator 115, linker 120, and program guide database 130 (collectively referred to as back office systems) are preferably implemented on one or more computers. Data paths 112, 117, 122, and 132 may be implemented using any suitable intra-computer or inter-computer methods or combination of methods. This may include inter-process messages, local area networks, wide area networks, or other such methods.

Interactive television equipment 150 displays messages, promotions, and optional program guide data for television viewers, as described in more detail below.

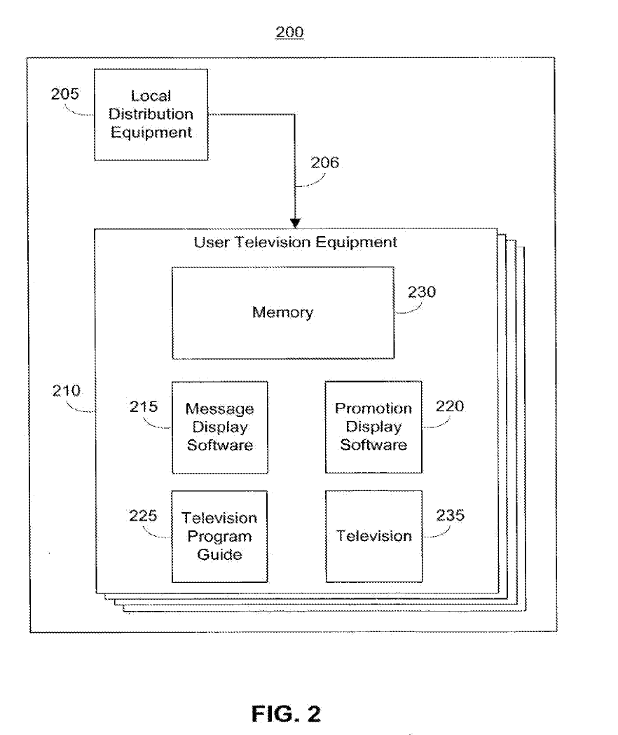

FIG. 2 shows a version 200 of interactive television equipment 150 of FIG. 1. Local distribution equipment 205 receives messages, promotions, and optional program guide data via data path 145 (FIG. 1) from distribution system 140 (FIG. 1). If desired, data may be received from multiple locations. Local distribution equipment 205 may be located at a cable headend facility, a satellite television uplink facility, a television broadcast facility, or similar location.

Local distribution equipment 205 may process messages, promotions, or program guide data prior to sending it to the user television equipment 210 via data path 206. Preferably multiple user television equipment 210 are present in the system. Data path 206 may be any suitable type of path, such as optical fiber, coaxial cable, telephone lines, over-the-air broadcast, paging frequencies, or satellite transmissions, as well as any suitable combination of such paths. Messages, promotions, and program guide data may be sent periodically, continuously, or on demand, or any suitable combination.

When messages, promotions, and program guide data are received, they may be stored in memory 230, which may be random access memory (RAM), disk, or any other suitable type of memory. They may be processed and stored in one or more database systems.

Optional television program guide 225 displays program guide data on television 235 (which can also be some other suitable display device such as a monitor). This is typically in response to user commands, but data may also be displayed independently of user commands. Television program guide 225 may display program guide data in a variety of formats, such as grids or lists, and may include various subsets of the data sorted in various ways, as known in the art. Television program guide 225 may also allow the television viewer to take various actions related to a program. For example, a viewer may be allowed to view additional information about a program, schedule a reminder for a program, purchase the program, record a program, find other air times for a program, or parentally control a program.

Message display software 215 displays messages on television 235. The display of messages may be unsolicited, for example displaying each new message as it is received. Alternatively, message display software may display messages based on user commands. For example, a list of available messages may be displayed, and the television viewer may select an individual message for display from that list.

Promotion display software 220 displays promotions on television 235 or other suitable display device such as a monitor. The promotions may be displayed as part of any other feature within the user television equipment 210. For example, promotions may be displayed on the television 235 concurrently with program guide data or with messages. Promotion display software 220 may allow the television viewer to select a promotion and take various actions related to the advertised item. For example, if the advertised item is a program and television program guide 225 is present, information about the program may be displayed, and the television viewer may be allowed to order the program, set a reminder for it, etc. If the promotion is for a product, the viewer may be allowed to request additional information about the product or purchase the product after selecting the promotion.

If a promotion is to be displayed concurrently with a message, promotion display software 220 checks to see if any available promotion is associated with the message. If so, promotion display software 220 displays the associated promotion, instead of or in addition to any other promotion which might otherwise be displayed.

If desired, message display software 215, promotion display software 220, and television program guide 225 may be combined as appropriate. For example, a message display application may include advertisement display as a feature. As another example, a television program guide may include both message display and promotion display as features.

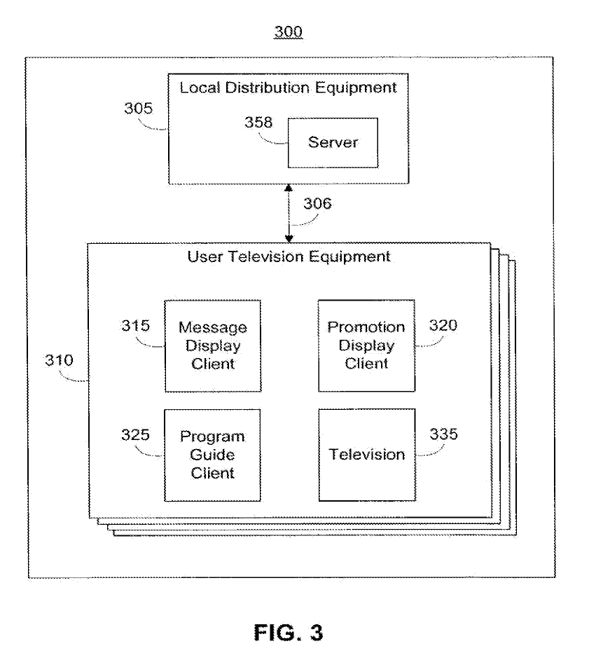

FIG. 3 shows a version 300 of interactive television equipment 150 (FIG. 1). Local distribution equipment 305 receives messages, promotions, and optional program guide data via data path 145 (FIG. 1) from distribution system 140 (FIG. 1). If desired, data may be received from multiple locations. Local distribution equipment 305 may be located at a cable headend facility, a satellite television uplink facility, a television broadcast facility, or similar location.

Local distribution equipment 305 includes server 358, on which messages, promotions, and program guide data may be stored. Local distribution equipment 305 may process messages, promotions, or program guide data prior to storing on server 358, or before sending it to the user television equipment 310 via data path 306. Preferably multiple user television equipment 310 are present in the system. Data path 306 may be any suitable type of path, such as optical fiber, coaxial cable, telephone lines, over-the-air broadcast, paging frequencies, satellite transmissions, or any suitable combination of such paths.

Optional program guide client 325 displays program guide data received from server 358 on television 335. This is typically in response to user commands, but data may also be displayed independently of user commands. Program guide client 325 may display program guide data in a variety of formats, such as grids or lists, and may include various subsets of the data sorted in various ways, as known in the art. Program guide client 325 may also allow the television viewer to take various actions related to a program. For example, a viewer may be allowed to view additional information about a program, schedule a reminder for a program, purchase the program, record a program, find other air times for a program, or parentally control a program. Examples of program guides with interactive information display screen features are illustratively shown in Rudnick et al., U.S. patent application No. 09/356,268, filed Jul. 16, 1999, which is hereby incorporated by reference herein in its entirety.

Message display client 315 may display messages received from server 358 on television 335. The display of messages may be unsolicited, for example displaying each new message as it is received. Alternatively, message display software may display messages based on user commands. For example, a list of available messages may be displayed, and the television viewer may select an individual message for display from that list.

Message display client 315 may be an electronic mail client. The electronic mail client may allow the television viewer to view various electronic mail messages, reply to messages, create new messages, maintain an address book, and other features that are well known in the art. Examples of program guides with messaging features are illustratively shown in Ellis et al., U.S. patent application Ser. No. 09/346,134, filed Jul. 16, 1999, McKissick et al., U.S. patent application Ser. No. 09/378,533, filed Aug. 20, 1999, and Knee et al. U.S. Pat. No. 5,589,892, which are hereby incorporated by reference herein in their entireties.

Promotion display client 320 displays promotions received from server 358 on television 335. The promotions may be displayed as part of any other feature within the interactive television equipment 300. For example, promotions may be displayed on the television 335 concurrently with program guide data or with messages. Promotion display client 320 may allow the television viewer to select a promotion and take various actions related to the advertised item. For example, if the advertised item is a program and program guide client 325 is present, information about the program may be displayed, and the television viewer may be allowed to order the program, set a reminder for it, etc. If the promotion is for a product, the viewer may be allowed to request additional information about the product or purchase the product after selecting the promotion.

If a promotion is to be displayed concurrently with a message, promotion display client 320 may check to see if any available promotion is associated with the message. If so, promotion display client 320 displays the associated promotion, instead of or in addition to any other promotion which might otherwise have been displayed.

If desired, message display client 315, promotion display client 320, and program guide client 325 may be combined as appropriate. For example, a message display client/server application may include advertisement display as a feature. As another example, a client/server television program guide may include both message display and promotion display as features.

If desired, some aspects may be resident in the user television equipment, and other aspects may use a server for remote storage. For example, a television program guide application may be wholly resident in the user television equipment, displaying program guide data from local memory, while the message display client may access electronic mail messages from a remote server.

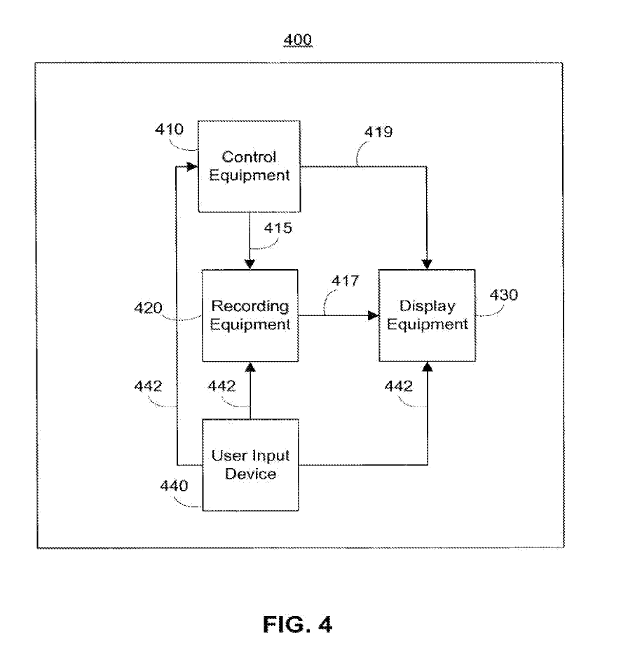

FIG. 4 shows a general block diagram 400 of user television equipment 210 (FIG. 2) or 310 (FIG. 3). Control equipment 410 receives television programming, along with messages, promotions, and optional program guide data, on data path 206 (FIG. 2) or 306 (FIG. 3). Data may be received on multiple paths. Control equipment 410 may also request messages, promotions, or program guide data, if server 358 (FIG. 3) is present. Control equipment 410 may also receive and send other information, if desired.

Control equipment 410 typically includes a computer processor and memory, such as RAM, ROM, PROM, Flash, disk, CD-ROM, or other type of memory, to hold software applications and data. Software applications held in this memory may include message display software 215 (FIG. 2) or 315 (FIG. 3), promotion display software 220 (FIG. 2) or 320 (FIG. 3), and television program guide 225 (FIG. 2) or 325 (FIG. 3). Data held in this memory may include messages, promotions, and program guide data.

Control equipment 410 may include circuitry for receiving and processing television signals, and for sending those television signals to display equipment 430 on data path 419. Display equipment 430 may be an analog or digital television, or other device suitable for displaying television signals. Signals may be sent or received as radio frequency (RF) signals, component audio and video baseband signals, digital signals encoded using a protocol such as MPEG-2, or the like.

Control equipment 410 may include circuitry for combining displays, such as text and graphics, with the television signal. For example, the program guide may display program guide data on top of a portion of the television program video, or instead of the video. The message display software may display messages on top of or instead of the video. The promotion display software may display promotions on top of or instead of the video, possibly in conjunction with messages or program guide data. Control equipment 410 may also include the ability to reduce the size of the video image and display other information (program guide data, messages, promotions, and the like) in the remaining space on the screen.

Control equipment 410 may be implemented in a set-top box. It may also be implemented in a television, videocassette recorder, personal computer, or other device with similar circuitry.

User television equipment 400 may also include optional recording equipment 420. Recording equipment 420 may be used for recording television programs, either automatically or under viewer command. Recording equipment 420 may be a videocassette recorder, disk drive, a personal video recorder, recordable DVD drive, or other device suitable for recording analog or digital video content. Recording equipment 420 may be incorporated into control equipment 410, into display equipment 430, or may be a separate unit.

Video may be sent to recording equipment 420 along data path 415. Recording equipment 420 may send video to display equipment 430 along data path 417. If these paths are present, they may replace data path 419 directly from control equipment 410 to display equipment 430.

Control equipment 410 may also send control signals to recording equipment 420 along data path 415. If recording equipment 420 is a videocassette recorder, for example, the control signals may be infrared signals, generated to mimic infrared control signals that might be sent from a handheld remote control.

The television viewer may control user television equipment 400 using user input device 440. User input device 440 may be, for example, a handheld remote control, a wireless keyboard, a handheld display/touchpad remote control, a joy stick, voice recognition device, or other suitable input device. If desired, user input device 440 may be used to control recording equipment 420 or display equipment 430 as well as control equipment 410, along data paths 442.

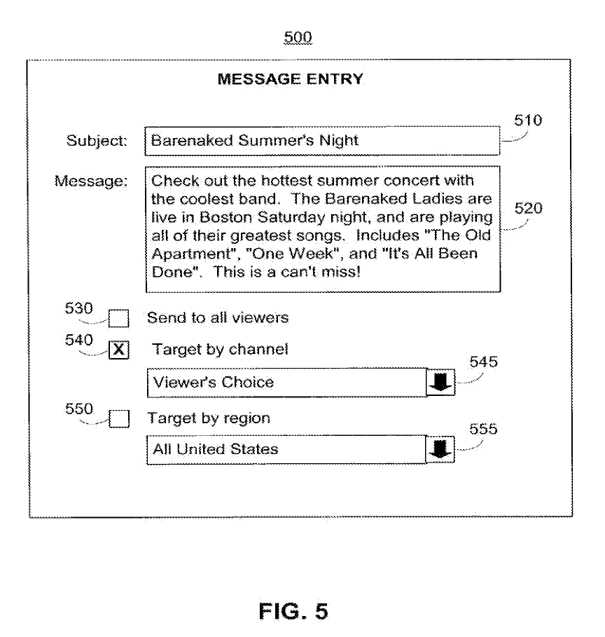

Message generator 110 (FIG. 1) may present a screen such as message entry screen 500 of FIG. 5 to allow the entry of messages. Region 510 may be used to enter the subject of the message. Region 520 may be used to enter the contents of the message.

The user may also be allowed to address the message to a subset of all television viewers. For example, the user may select check box 530 to indicate that the message should be sent to all viewers. The user may select check box 540 to indicate that the message should be sent only to television viewers who can receive a particular television channel or group of television channels. The user may use drop-down list 545 to select the channel or group of channels. Alternatively, the user may type in the name of a channel or network, or enter a unique ID number. The user may select check box 550 to indicate that the message should be limited to television viewers in a particular geographical region, or other identified group of television viewers. The user may use drop-down list 555 to specify the region or group, or type in the name or identifier of the region or group. The user may also be allowed to address a message to an individual television viewer or household, or to subsets of viewers defined by other criteria such as one or more purchasing circles.

Purchasing circles (e.g., book clubs) may be used as a means for targeting advertisements. The option to purchase the book being discussed on a show having a book club may be presented on the user equipment as an overlay to the television program discussing the book. Purchasing circles may be promoted to viewers based on their viewing habits of certain programs. The purchasing circle may be integrated with the interactive program guide. For example, the purchasing circle may be accessed through the program guide. Accessing the purchasing circle may be done, in some embodiments, by selecting a graphic that is displayed with the program listings. The option to receive messages with accompanying advertisements related to a show may be presented to the user as a graphic with the program listing for that particular show. Additionally, a graphic may be presented with a program listing when items are available for purchase with the program of a particular listing. Different graphics may be presented within the program guide to indicate various purchasing circle features and offerings associated with the program listings.

In addition to being the criteria for targeting electronic messages and advertisements, purchasing circles may also be the subject matter of targeted advertisements and electronic messages. Similarly to the targeting of advertisements, purchasing circles may be targeted based on any criteria capable of being classified and/or tracked by the system operator concerning its viewers and/or obtained from a third party vendor (e.g., demographic data, affiliation information, information on past purchases and/or internet preferences). Targeting purchasing circles to members of a local civics group is one example of such targeting. Users may also have the option to opt out of receiving future messages directed to one or more groups. Purchasing circles may be advertised via e-mail messages, advertisements, graphics, etc.

Message creation features may be specified on any screen or set of screens similar to message entry screen 500 of FIG. 5. For example, electronic mail software may be used to create, address, and send messages. Messages may also be generated automatically, for example by a system that generates messages to promote pay-per-view programs.

After a message is entered, message generator 110 (FIG. 1) may perform verification checks to ensure that all required fields are present and contain valid values. Messages may then be sent to linker 120 (FIG. 1), or may be sent to distribution system 140 (FIG. 1) for distribution.

Messages may be targeted to previous viewers of programs or previous purchasers of products. For example, if a user orders merchandise related to an event, a team, or any feature distinguishing the merchandise, the user may be sent e-mail messages advertising similar items in the future. Past viewing habits may also be used in targeting messages. For example, previous viewers or purchasers of PPV events (e.g., boxing, wrestling, concerts, etc.) and other programming may be sent e-mail messages advertising similar programming in the future. Targeting of advertisements may be performed by any criteria capable of being classified and/or tracked by the system operator concerning its viewers and/or obtained from a third party vendor (e.g., demographic data, affiliation information, information on past purchases and/or internet preferences). Viewing habits may be tracked by set-top boxes, demographic data may be collected and provided by cable system headends, and preferences may be entered by users via the set-top box or the internet. These means of collecting data for the purpose of targeting advertising are only illustrative examples.

Additionally, video-on-demand and near video-on-demand advertisements may be targeted based on past viewing habits. Using the past viewing habits or purchases, users may be sent information on related programming. For example, if a viewer were to watch a single episode of the Honeymooners on regular television or via video-on-demand, the system may take note of this fact and generate a message to the viewer that a package of episodes (including rarely broadcast “lost” episodes) is available for viewing at a discounted price. The system may also generate messages to the viewer for programming of a similar nature (e.g., same genre, same actors, other viewers who watched the programming that triggered the message also ordered the program being advertised, etc.) that may be available as a single program or as a package of episodes. Once a viewer purchases a package of episodes, the system may periodically send messages to the viewer informing him or her as to the number of programs left in the package. Video-on-demand and near video-on-demand purchase and viewing habits may trigger e-mail messages advertising PPV and regular television programming, just as viewing habits of regular television and purchase histories of PPV events may trigger e-mail messages advertising video-on-demand and near video-on-demand packages and offers. An interactive messaging system may also interact with a program guide to automatically set the programs in the package for recording and/or reminding.

In any of the embodiments described, a user may have the option to add himself to a distribution list. Users and operators may also have the ability to add audio/visual content to messages.

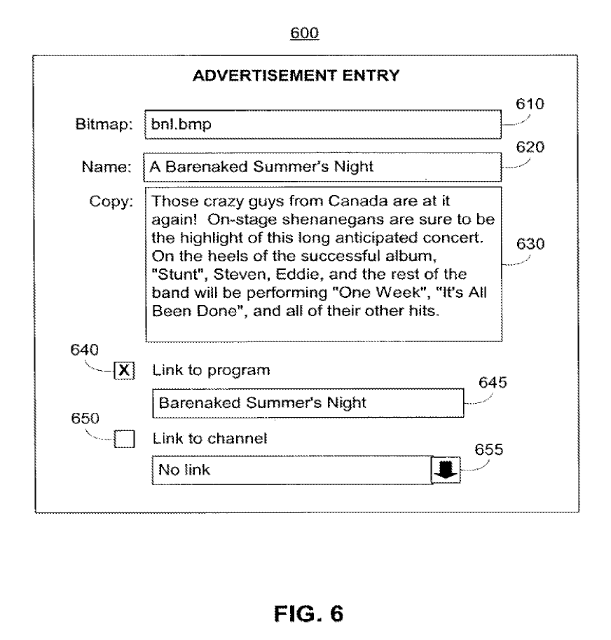

Promotion generator 115 (FIG. 1) may present a screen such as screen promotion entry 600 of FIG. 6 to allow the entry of promotions. Region 610 may be used to enter the name of, for example, a graphic file to be displayed as part of the advertisement. Instead of a graphic file, an applet, interactive program, video advertisement or series of items to be displayed in succession may be specified. Region 620 may be used to enter the title of the promotion or of the item being promoted. Region 630 may be used to enter in the text copy for the promotion, which may be written in the format of hyper-text markup language (“HTML”) text capable of being displayed in Internet browsers, applets and/or links to additional interactive content.

The user may also be allowed to link the promotion to specific television programming. For example, the user may select check box 640 to indicate that the promotion should be linked to a specific television program. The user may use entry field 645 to enter the name of the program or other identifying information. The user may select check box 650 to indicate that the promotion should be linked to a specific television channel or network. The user may use drop-down list 655 to specify the channel or network, or type in the name or identifier of the channel or network. The user may also be allowed to link a promotion based on other criteria or groups of criteria.

These and other promotion creation features may be specified on any similar screen or set of screens.

After a promotion is entered, promotion generator 115 (FIG. 1) may perform verification checks to ensure that all required fields are present and contain valid values. The promotion may then be sent to linker 120 (FIG. 1), or may be sent to distribution system 140 (FIG. 1) for distribution.

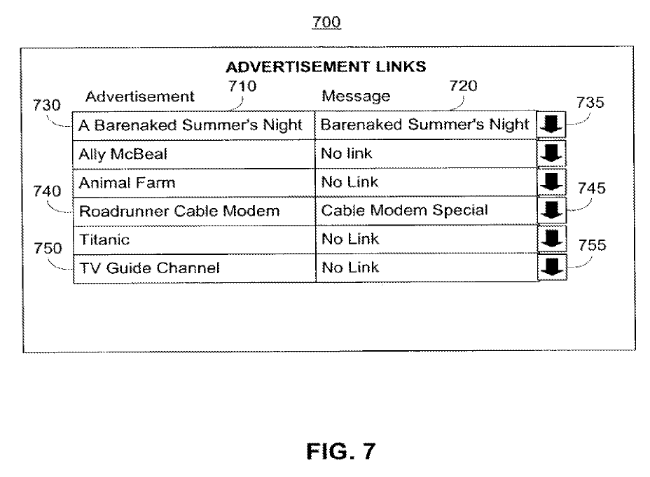

Linker 120 (FIG. 1) may present a screen such as a linking screen 700 as shown in FIG. 7 to allow the association of promotions to messages. Column 710 may list each of the promotions available to be linked. Column 720 may allow the selection of a message to be associated with each promotion.

For example, box 730 shows the advertisement created on promotion entry screen 600 (FIG. 6). Drop down list 735 has been used to select the message created on message entry screen 500 (FIG. 5). This shows an example of an advertisement for a television program that has been associated with a message regarding that program. Similar links may be created for promotions and messages regarding television channels, television networks, groups of television programs, or other services offered via a television distribution system.

Box 740 shows an advertisement created on a screen similar to promotion entry screen 600 (FIG. 6) for a cable modem. Drop down list 745 has been used to select a message created on a screen similar to message entry screen 500 (FIG. 5) regarding the same cable modem. Similar links may be created for promotions and messages regarding any other product or service that may or may not be available for interactive purchase.

Box 750 and drop down list 755 show an advertisement that is not associated with any message. Promotions that are not linked to messages may also be supported. These unlinked promotions may be displayed at times other than when displaying messages. They may also be displayed along with messages that are not associated with any promotions, or at the same time as an associated promotion.

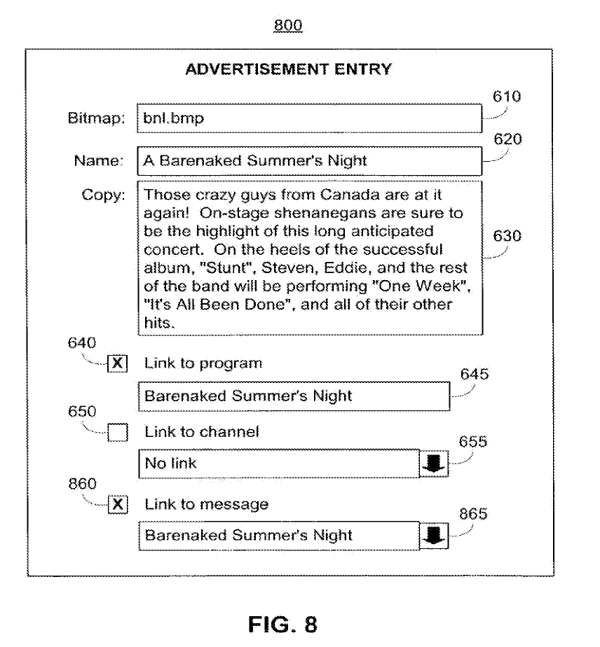

Promotion entry screen 800 of FIG. 8 shows an alternative version of promotion entry screen 600 (FIG. 6), which also allows linking of the promotion with a message, as described above in the description of linking screen 700 (FIG. 7). Bitmap entry box 610, promotion name box 620, and promotion copy box 630 are as described above. Also, program link check box 640, program link entry box 645, channel link check box 650, and channel link selection drop down list 655 are as described above.

Check box 860 allows a promotion to be associated with a message at the same time that it is created. Drop down list 865 allows the user to choose which message is to be associated with the promotion. This screen may also be displayed after the promotion has been created, to add or change information that wasn't available at the time of creation.

Promotions may automatically be associated with messages. When a user or operator generates a message, the content of the message may be scanned (by the user equipment, the cable system operator equipment, or any appropriate equipment along the distribution/delivery path of the electronic message). Once the content has been scanned, related promotions (or operator-chosen, or random promotions if so desired) may be automatically linked to the message. Thus, an automatically associated promotion is delivered with the message. In some embodiments the messages and promotions may be automatically linked because they share common key words in their subject lines. In other embodiments, promotions may have a list of target words associated with them that are searched for among the entire content of the electronic messages.

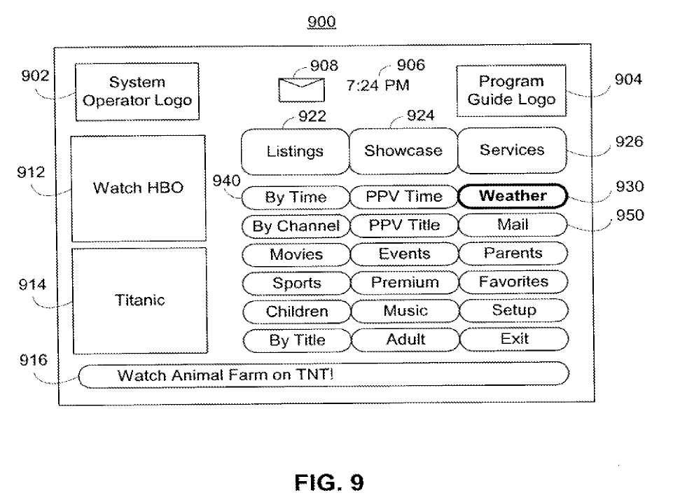

Main menu screen 900 of FIG. 9 is an illustrative main menu screen of a television program guide 225 (FIG. 2). As discussed above, messaging and promotion features may be incorporated into television program guide 225 (FIG. 2), or they may be offered separately. A similar screen may be displayed for either television program guide 225 (FIG. 2) or program guide client 325 (FIG. 3). Main menu screen 900 may be displayed in response to a television viewer pressing a “Menu” key on a handheld remote control.

The system operator logo 902 and the program guide logo 904 may be displayed to brand the screen. Current time 906 may alternate every two seconds with the currently tuned channel number and call sign. Message indicator 908 may be displayed whenever a message is available to be read.

Advertisements 912, 914, and 916 may be displayed as part of main menu screen 900. Advertisement 912 is a graphical promotion for the channel HBO. If a television viewer selects advertisement 912, the program guide may present a description of HBO, along with the options to watch HBO, view listings for HBO, order HBO, set HBO as a favorite channel, or parentally lock HBO. Advertisement 914 is a graphical promotion for the PPV program Titanic. If a television viewer selects advertisement 914, the program guide may present a description of the movie, along with options to watch a video preview for Titanic, order Titanic, and see other airing times. Advertisement 916 is a text advertisement for the program Animal Farm on the channel TNT. If a television viewer selects advertisement 916, the program guide may present a graphic representation of the program along with a description of the program, along with options to set a reminder for the program, view other air times, or parentally lock the program or channel it appears on.

Options on main menu screen 900 may be organized into multiple groups. For example, listings group 922 includes options to view program guide data organized by time 940, by channel, by category, and by title. Showcase group 924 includes options to view lists of PPV programs, premium channels, music channels, and other services the system operator may wish to highlight. Services group 926 includes options to view weather information, read electronic mail messages 950, set up parental control options, define favorite channels, set up various options of the program guide, and exit the main menu screen 900.

The television viewer may navigate about the main menu screen 900 by pressing arrow keys on the handheld remote control to move highlight region 930. The television viewer may then press OK, Select, Enter, or the equivalent on the handheld remote control to select the highlighted option and access other features of the program guide.

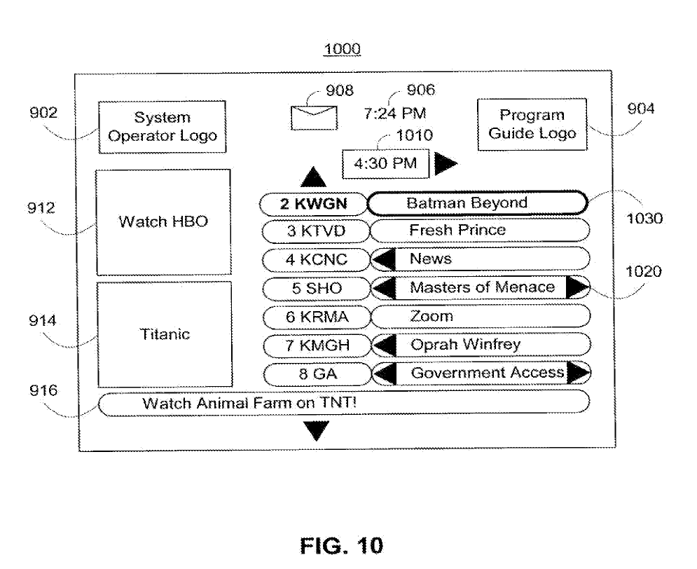

If the user selects the By Time option 940 of main menu screen 900, the program guide may display program guide data on a screen such as listings by time screen 1000 of FIG. 10. Listings by time screen 1000 may also be displayed if the television viewer presses a “Guide” key on the handheld remote control.

Listings by time screen 1000 may include logos 902 and 904, current time and channel 906, message indicator 908, and advertisements 912, 914, and 916 as described above. It may also include listings time indicator 1010. Listings shown in listings area 1020 correspond to the time shown in listings time indicator 1010. If the user presses a right arrow key on the handheld remote control, for example, the program guide might increase the time shown by thirty minutes, and display the program guide data for the selected time. The television viewer may press up or down arrow keys on the handheld remote control, and move the highlight region 1030 to any of the program listings or advertisements. Pressing a key on the remote such as OK, Select, or Enter would cause the program guide to perform an action related to the selection, such as tuning to the selected program or displaying information related to the selection.

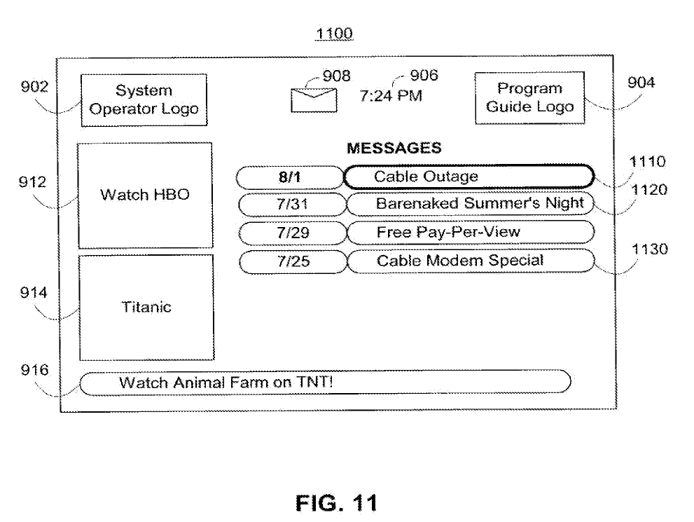

If the viewer selects Mail option 950 (FIG. 9) of main menu screen 900 (FIG. 9), the program guide may display a list of messages on a screen such as message listing screen 1100 of FIG. 11. Message listing screen 1100 may also be displayed if the television viewer presses a “Mail” key on the handheld remote control.

Message listing screen 1100 may include logos 902 and 904, current time and channel 906, message indicator 908, and advertisements 912, 914, and 916 as described above. Messages may be listed on this screen, sorted by date and time of receipt, and including the date of receipt and the subject of the message. The television viewer may press up or down arrow keys on the handheld remote control, and move the highlight region 1110 to any of the messages or advertisements. Pressing a key on the remote such as OK, Select, or Enter would cause the program guide to display the message.

In this example, message listing 1120 corresponds to the message entered on message entry screen 500 (FIG. 5), which is a message related to a program. Message listing 1130 is another type of message related to a product for sale. An icon or other visible interactive or non-interactive indicator may be used to indicate the presence of a link to a promotion or an advertisement associated with the message. Similar icons and indicators may be automatically inserted into messages forwarded by one user to another (e.g., a pay-per-view purchase icon for a program being promoted by the message). In some embodiments, rather than inserting the icons and indicators into the messages, the icons and indicators may be displayed with a message based on information that may be inserted into or forwarded with the message.

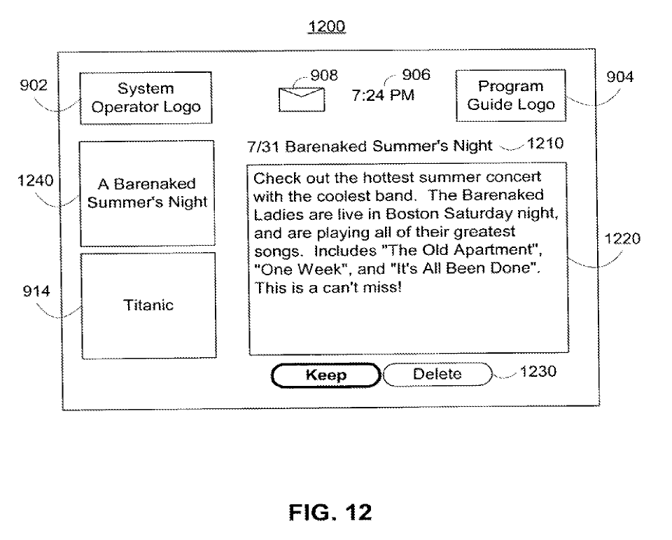

The program guide may display message screen 1200 of FIG. 12 in response when the viewer selects message listing 1120 (FIG. 11). Message screen 1200 may include logos 902 and 904, current time and channel 906, message indicator 908, and advertisement 914 as described above. Message screen 1200 may also include the date and subject of the message 1210, the text of the message 1220, and selectable options related to the message 1230. If the viewer presses up or down, arrow keys on the handheld remote control, the program guide may display additional text of the message in text box 1220, if not all of the text will fit onto a single screen. If the viewer highlights the Keep option (as shown) and presses a key such as Select on the handheld remote control, the program guide may retain the message and return to message listing screen 1100 (FIG. 11). If the viewer highlights the Delete option and presses a key such as Select on the handheld remote control, the program guide may delete the message and return to message listing screen 1100 (FIG. 11).

When the program guide displays message screen 1200, it checks to see if there is an advertisement or other promotion associated with the message to be displayed. This may be done by checking the linking information sent over data path and stored in memory 230 (FIG. 2), or by checking linking information stored on server 358 (FIG. 3) over data path 306 (FIG. 3). If there is no associated advertisement or other promotion, the program guide may display the regularly scheduled advertisements 912 (FIG. 11) and 914 (FIG. 11). If there is an associated advertisement, the program guide replaces one of the regularly scheduled advertisements with the associated advertisement 1240. In this case, the program guide may display the remaining regularly scheduled advertisement 914 as shown, or it may display only the associated advertisement 1240.

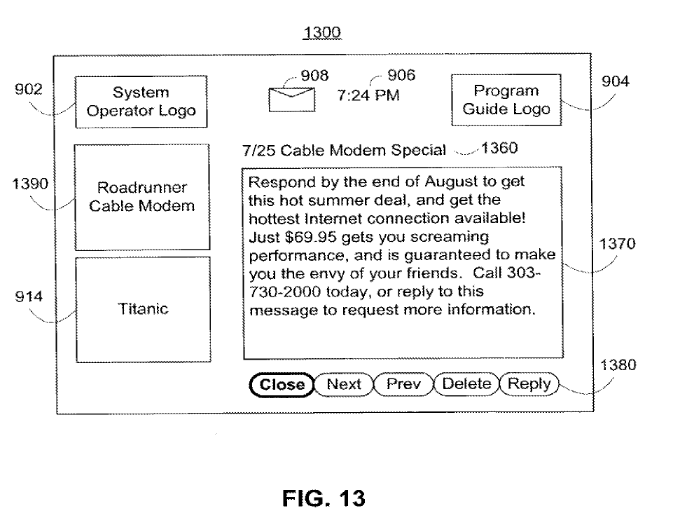

The program guide may display message screen 1300 of FIG. 13 in response when the viewer selects message listing 1130 (FIG. 11). Message screen 1300 illustrates how a program guide might display a mail message if it implements an electronic mail feature. Message screen 1300 may include logos 902 and 904, current time and channel 906, message indicator 908, and advertisement 914 as described above. Message screen 1300 may also include the date and subject of the message 1360, the text of the message 1370, and selectable options related to the message 1380. If the viewer presses up or down arrow keys on the handheld remote control, the program guide may display additional text of the message in text box 1370, if not all of the text will fit onto a single screen. If the viewer highlights the Close option (as shown) and presses a key such as Select on the handheld remote control, the program guide may retain the message and return to message listing screen 1100 (FIG. 11). If the viewer highlights the Next option and presses a key such as Select on the handheld remote control, the program guide may display the next message from message listing screen 1100 (FIG. 11). In this example, there is no next message, and the program guide might close the current message and return to message listing screen 1100 (FIG. 11). If the viewer highlights the Prev option and presses a key such as Select on the handheld remote control, the program guide may display the previous message from message listing screen 1100 (FIG. 11), in this example the “Free Pay-Per-View” message. If the viewer highlights the Delete option and presses a key such as Select on the handheld remote control, the program guide may delete the message and return to message listing screen 1100 (FIG. 11). If the viewer highlights the Reply option and presses a key such as Select on the handheld remote control, the program guide may allow the viewer to enter an electronic mail response to the current message.

When the program guide displays message screen 1300, it checks to see if there is an advertisement associated with the message to be displayed. This may be done by checking the linking information sent over the data path and stored in memory 230 (FIG. 2), or by checking linking information stored on server 358 (FIG. 3) over data path 306 (FIG. 3). If there is no associated advertisement, the program guide may display the regularly scheduled advertisements 912 (FIG. 11) and 914 (FIG. 11). If there is an associated advertisement, the program guide may replace one of the regularly scheduled advertisements with the associated advertisement 1390. In this case, the program guide may display the remaining regularly scheduled advertisement 914 as shown, or it may display only the associated advertisement 1390.

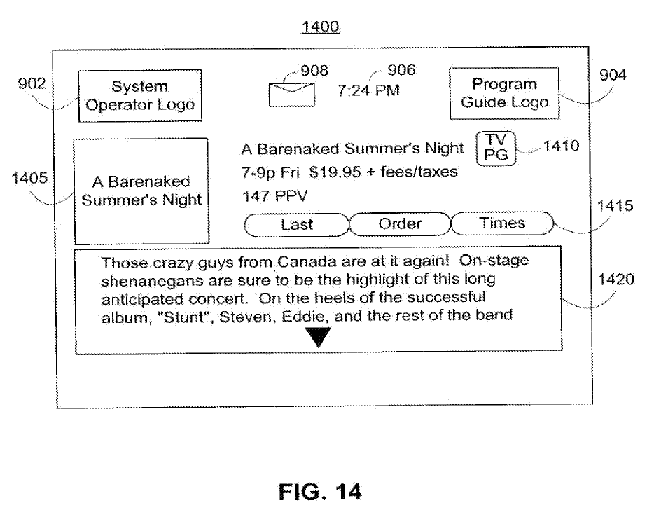

In response to the viewer selecting advertisement 1240 (FIG. 12), the program guide may display information screen 1400 as illustrated in FIG. 14. Information screen 1400 may include logos 902 and 904, current time and channel 906, and message indicator 908 as described above. It may also include graphical interactive advertisements and video clips associated with the program which might be automatically displayed or be selectable by the user. Advertisement 1405 may be a duplicate of the advertisement 1240 (FIG. 12) used to access information screen 1400. However, advertisement 1405 may not be selectable.

Information screen 1400 may include program details area 1410. Program details area 1410 may include information such as the title of the program, its rating, its time and channel, and its price. Program options 1415 may include selectable options relating to the program. The viewer may press a left or right arrow key on the handheld remote control to highlight one of the options, and press a key such as a Select key on the handheld remote control to select the option. Selecting the Last option may return to message screen 1200 (FIG. 12). Selecting the Order option may allow the viewer to purchase the pay-per-view program. Selecting the Times option may allow the viewer to view alternate air times for the program. Other options, not shown, may include options to set a reminder for the program, record the program, add the program or any of its attributes to a preference profile, parentally control the program, view a video clip of the program, or any other options related to the program. Examples of program guide systems with preference profile features are illustratively shown in Satterfield et al., U.S. patent application Ser. No. 09/054,917, filed Apr. 2, 1998, which is hereby incorporated by reference herein in its entirety. Text description box 1420 includes the text description of the advertised program, originally entered on promotion entry screen 600 (FIG. 6) or on promotion entry screen 800 (FIG. 8). The viewer may press an up or down arrow key on the handheld remote control to view additional text if there is more text than will fit into text description box 1420.

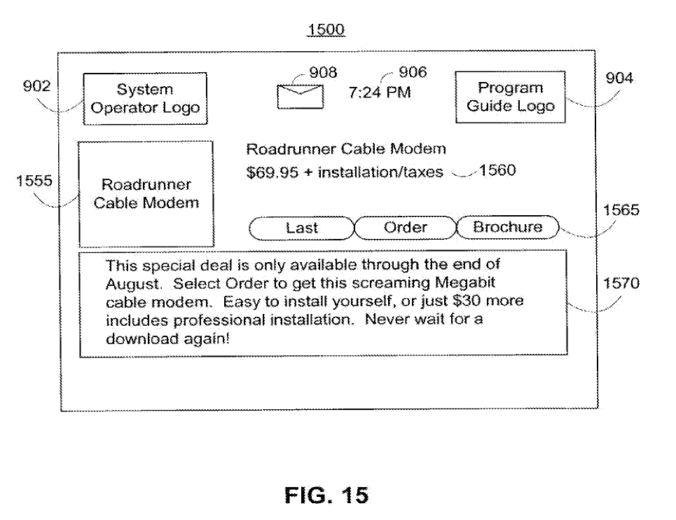

In response to the viewer selecting advertisement 1390 (FIG. 13), the program guide may display information screen 1500 as illustrated in FIG. 15. Information screen 1500 may include logos 902 and 904, current time and channel 906, and message indicator 908 as described above. Advertisement 1555 may be a duplicate of the advertisement 1390 (FIG. 13) used to access information screen 1500. However, advertisement 1555 may not be selectable.

Information screen 1500 may include product details area 1560. Product details area 1560 may include information such as the name of the product and its price. Product options 1565 may include selectable options relating to the product such as a last option, an order option, or a brochure option. The viewer may press a left or right arrow key on the handheld remote control to highlight one of the options, and press a key such as a Select key on the handheld remote control to select the option. Selecting the Last option may return to message screen 1300 (FIG. 13). Selecting the Order option may allow the viewer to purchase the product. Selecting the Brochure option may allow the viewer to request a brochure for the product. Other options, not shown, may include options to access a web site for the product, view a picture or video of the product, or any other options related to the product. Text description box 1570 includes the text description of the advertised product. The viewer may press an up or down arrow key on the handheld remote control to view additional text if there is more text than will fit into text description box 1570.

Messages 1200 (FIG. 12) and 1300 (FIG. 13) and promotions 1400 (FIG. 14) and 1500 (FIG. 15) might also have the option of being forwarded to third parties. Before the message is forwarded, the system can prompt the user to purchase the advertised item on behalf of the third party or to purchase a gift certificate which the third party can use in the purchase of the item or some other item. Additional promotional graphical content may be presented to a user in the course of forwarding a message (e.g., the user may be offered a discount on the promoted item of the message). Furthermore, additional content may be automatically added to the forwarded message (e.g., purchase icons, discounts, etc.).

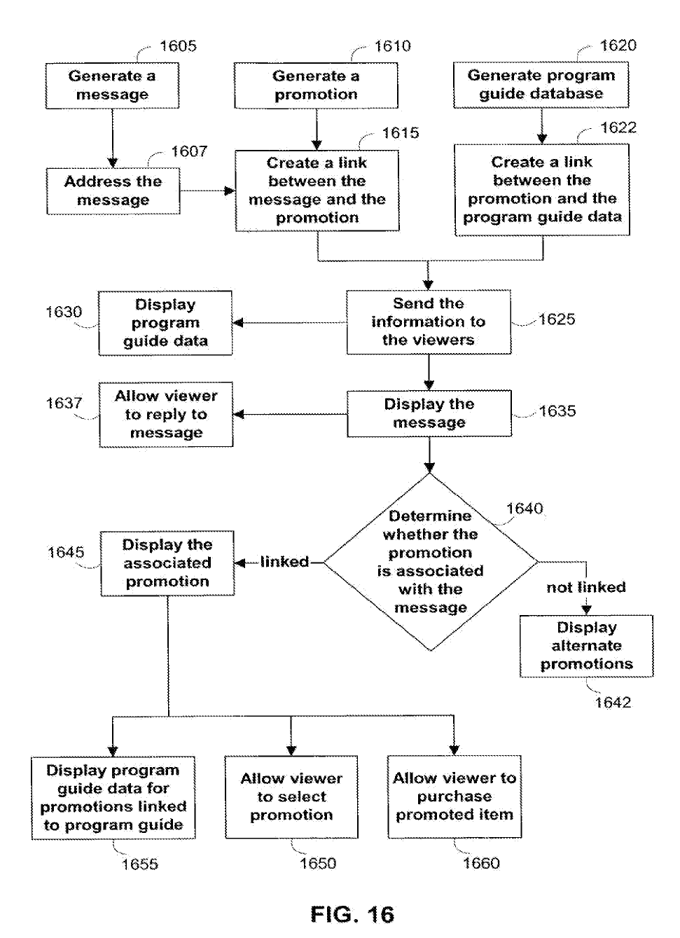

FIG. 16 shows a flow chart of illustrative steps involved in implementing the features illustratively described herein. Steps shown may be executed in any order, and any steps may be omitted as appropriate.

In step 1605, a message is generated. In step 1607 the message may be addressed to a subset of television viewers. These two steps may be done by message generator 110 (FIG. 1) using message entry screen 500 (FIG. 5).

In step 1610, a promotion is generated. This may be done by promotion generator 115 (FIG. 1) using promotion entry screen 600 (FIG. 6) or promotion entry screen 800 (FIG. 8). In step 1615, a link is created between the promotion and the message. This may be done by linker 120 (FIG. 1) using linking screen 700 (FIG. 7) or promotion entry screen 800 (FIG. 8).

If the system includes a program guide, the program guide database 130 (FIG. 1) may be generated in step 1620. Links between the promotion and the program guide database may be created in step 1622, for example using promotion entry screen 600 (FIG. 6) or promotion entry screen 800 (FIG. 8).

In step 1625, the messages, promotions, links, and program guide data are sent to the television viewers. This may be done using distribution system 140 (FIG. 1) and local distribution equipment 205 (FIG. 2) or 305 (FIG. 3). The program guide may display program guide data in step 1630, for example as shown in program listing screen 1000 (FIG. 10).

In step 1635, the message may be displayed for the television viewer. Two examples of message display screens are shown in message screen 1200 (FIG. 12) and message screen 1300 (FIG. 13). In step 1637, the television viewer may be given the opportunity to reply to the message. If desired, the user can be given the option to forward the message.

In step 1640, the interactive television application checks to see if there is a promotion associated with the message. If such an association does not exist, the message is displayed with alternate promotions, such as regularly scheduled promotions in step 1642. If a promotion is associated with the message, the associated promotion is displayed in step 1645.

The viewer may be given the opportunity to select the promotion in step 1650. The system may respond by displaying a screen such as information screen 1400 (FIG. 14) or information screen 1500 (FIG. 15). If the promotion is for television programming, and the promotion is linked to the program guide database, program guide data may be displayed in step 1655. The viewer may be given the opportunity to purchase the promoted program or item in step 1660.

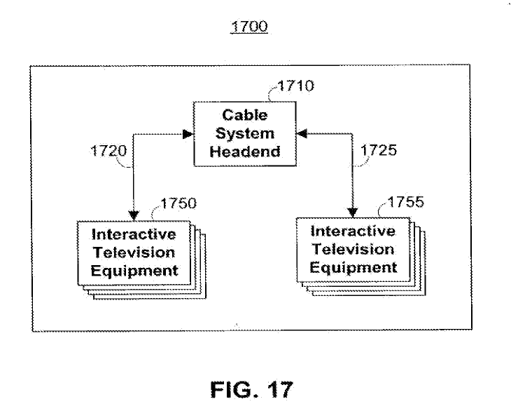

An illustrative interactive television system is shown in FIG. 17. System 1700 may include cable system headend 1710 linked to subscribers 1750 and 1755 along data paths 1720 and 1725. Components other than cable system headend 1710 may be required to operate interactive television system 1700, and the system may have more than two subscribers 1750 and 1755. However, this illustrative system has been shown in this simplified form for the sake of the following discussion. Subscriber 1750 may generate or forward a message for subscriber 1755. Data paths 1720 and 1725, via cable system headend 1710 may be one route for the message to travel. During the delivery process of the message, a promotion may be linked to the message based on the content of the message. The content may be scanned at cable system headend 1710 for association with a promotion. Alternatively, in systems in which promotional content may be stored locally on user equipment, the message may be scanned locally for association with a promotion. Once a promotion has been linked to the message, both the message and the promotion may be provided to the recipient (e.g., subscriber 1755).

Cable system headend 1710 may operate a television mail system and/or a television chat system. In such systems, users are able to send e-mail messages or chat messages to one another. In some illustrative systems, the e-mail messages and chat messages are about the program that the users are watching. Therefore, a link between a television program and a message is already established. Additionally, the television system may use this link information to link an appropriate advertisement to the e-mail message or chat message. Illustrative advertisements for linking to such messages could be advertisements for future broadcasts of other episodes of the subject-matter program, for programs of the same genre as the subject-matter program, or for merchandise related to the subject-matter program. Based on the program-message link, or based on other message content scanned by the system, the system may select and link an appropriate advertisement.

If desired, platforms for messaging and related promotions systems may extend beyond interactive television program guides. Similar systems for providing a message and a promotion to a user and establishing a link between the message and the promotion may be provided on personal computer equipment. The messaging and related promotions system may operate over the Internet. Other illustrative platforms for the messaging and related promotions system may be a wireless telecommunications network or a network of handheld devices (such as, Personal Data Assistants (PDAs)).

The foregoing is merely illustrative of the principles of this invention and various modifications can be made by those skilled in the art without departing from the scope and spirit of the invention. Therefore, the spirit and scope of the appended claims should not be limited to the description of the preferred embodiments contained herein.

1-188. (canceled)

189. A method for providing a message linked to a promotion on an interactive user equipment system, comprising:
receiving with the interactive user equipment system, a plurality of messages and a plurality of promotions from a first remote location, wherein at least one of the plurality of messages includes a link to a promotion associated with the message;
accessing one of the plurality of messages;
determining whether the accessed message is linked to a promotion;
displaying the accessed message in a first portion of an electronic media guide;
in response to determining that the accessed message is linked to a promotion, accessing the promotion linked to the accessed message;
in response to determining the accessed message is not linked to a promotion, accessing an alternate promotion; and
simultaneously displaying the linked promotion in a second portion, wherein the first portion and the second portion are substantially non-overlapping.

190. The method defined in claim 189 further comprising determining whether the linked promotion is further linked to program guide data.

191. The method defined in claim 190 further comprising accessing the program guide data.

192. The method defined in claim 191, wherein the program guide data is displayed in a third portion of the electronic media guide.

193. The method defined in claim 189, wherein the linked promotion is associated with a promoted item.

194. The method defined in claim 193, wherein the promoted item is television programming.

195. The method defined in claim 189, wherein the linked promotion is an interactive promotion.

196. The method defined in claim 195 comprising receiving a viewer selection of the interactive promotion.

197. The method defined in claim 196 comprising allowing the viewer to purchase a promoted item associated with the selected promotion.

198. A user equipment of an interactive equipment system that utilizes an interactive guide application for providing a message linked to a promotion, comprising:
circuitry configured to receive a plurality of messages and a plurality of promotions from a first remote location, wherein at least one of the plurality of messages includes a link to a promotion associated with the message;
a memory configured to store the plurality of messages, the plurality of promotions, and the interactive guide application;
a processor configured to
access one of the plurality of messages;
determine whether the accessed message is linked to a promotion;
enable a display equipment to display the accessed message in a first portion of an electronic media guide;
in response to determining that the accessed message is linked to a promotion, access the promotion linked to the accessed message;
in response to determining the accessed message is not linked to a promotion, access an alternate promotion; and
enable the display equipment to simultaneously display the linked promotion in a second portion, wherein the first portion and the second portion are substantially non-overlapping.

199. The system defined in claim 198, wherein the processor is further configured to determine whether the linked promotion is further linked to program guide data.

200. The system defined in claim 199, wherein the processor is further configured to access the program guide data.

201. The system defined in claim 200, wherein the processor is further configured to enable the display equipment to display the program guide data in a third portion of the electronic media guide.

202. The system defined in claim 198, wherein the linked promotion is associated with a promoted item.

203. The system defined in claim 202, wherein the promoted item is television programming.

204. The system defined in claim 198, wherein the linked promotion is an interactive promotion.

205. The system defined in claim 204 comprising receiving a viewer selection of the interactive promotion.

206. The system defined in claim 205 comprising allowing the viewer to purchase a promoted item associated with the selected promotion.
